(19) United States
(12) Patent Application Publication
(10) Pub. No.: US 2013/0329800 A1
(43) Pub. Date: Dec. 12, 2013

(54) METHOD OF PERFORMING PREDICTION FOR MULTIVIEW VIDEO PROCESSING

(71) Applicant: Samsung Electronics Co., Ltd., Suwon (KR)

(72) Inventors: Kovliga Igor Mironovich, Chashnikovo (RU); Fartukov Alexey Mikhailovich, Moscow (RU); Mishourovsky Mikhail Naumovich, Moscow (RU); Rychagov Mikhail Nikolaevich, Moscow (RU)

(73) Assignee: SAMSUNG ELECTRONICS CO., LTD., Suwon (KR)

(21) Appl. No.: 13/911,517

(22) Filed: Jun. 6, 2013

(30) Foreign Application Priority Data
Jun. 7, 2012 (RU) 2012123519
Jun. 5, 2013 (KR) 10-2013-0064832

(51) Int. Cl. H04N 7/32

(52) U.S. Cl. CPC H04N 19/00769; H04N 19/00763
USPC 375/240.16

(57) ABSTRACT

Provided is a method of performing prediction for Multi-view Video with Depth information (MVD) data processing, by which a virtual motion vector (VMV) may be obtained using a synthesized current frame obtained from a current frame, and a synthesized reference frame obtained from a reference frame, a refined motion vector (RMV) may be obtained by refining the VMV through template matching (TM), and a final motion vector (FMV) may be determined by comparing the RMV to a zero motion vector (ZMV).

### CROSS-REFERENCE TO RELATED APPLICATIONS

This application claims the priority benefit of Russian Patent Application No. 2012123519, filed on Jun. 7, 2012, in the Russian Patent and Trademark Office, and Korean Patent Application No. 10-2013-0064832, filed on Jun. 5, 2013, in the Korean Intellectual Property Office, the disclosures of which are incorporated herein by reference.

### BACKGROUND

1. Field

Example embodiments relate to a method of performing prediction for multiview video processing.

2. Description of the Related Art

Multiview video with depth information (MVD) data refers to data including depth information and video frames from multiple views. MPEG-4 AVC/H.264 Annex. H Multiview Video Coding (MVC) suggests a method of encoding an MVD video. The MVD video may be encoded as a set of video sequences.

A prediction block may be generated using an already encoded and decoded reference frame. In order for an encoder and a decoder to generate a prediction block, side information may be necessary. For example, the side information may include a macroblock type, a motion vector, indices of reference frames, modes of spitting a macroblock, and the like. The side information may be generated by the encoder, and transferred to the decoder in a form of a compressed bit stream, hereinafter, referred to as “stream”. The more accurate the side information is, the more precise the prediction block is, and the lower amplitude of residuals in a residual block is. In contrast, the more accurate the side information is, the more bits are to be transferred to the decoder.

### SUMMARY

The foregoing and/or other aspects are achieved by providing a method of performing prediction for multiview video processing, the method including determining a synthesized current frame corresponding to a current frame, determining a synthesized current block in the synthesized current frame corresponding to a current block in the current frame, determining a synthesized reference frame corresponding to a reference frame of the current frame, obtaining at least one motion vector from the synthesized current block and the synthesized reference frame, and determining a prediction block for the current frame using the at least one motion vector.

The obtaining may include setting a restricted reference zone within the synthesized reference frame, determining at least one candidate block within the restricted reference zone, determining a synthesized reference block among the at least one candidate block, by comparing the at least one candidate block to the synthesized current block, and determining the at least one motion vector from the synthesized current block and the determined synthesized reference block.

The method may further include obtaining a refined motion vector (RMV) by refining the at least one motion vector through template matching (TM), and the determining of the prediction block may include determining the prediction block for the current frame using the RMV. The obtaining of the RMV may include determining a first template related to the current block, determining a best displacement related to the reference frame and the first template through the TM, and obtaining the RMV by adding the determined best displacement to the at least one motion vector.

The method may further include determining a final motion vector (FMV) between the RMV and a zero motion vector (ZMV), by comparing the RMV and the ZMV after the RMV is obtained. The ZMV may be determined by referring to the current block and the reference frame. In this instance, the determining of the FMV may include calculating a first similarity between a template of the current block and a template indicated by the ZMV within the reference frame, calculating a second similarity between the template of the current block and a template indicated by the RMV within the reference frame, and determining the FMV between the RMV and the ZMV, by comparing the first similarity to the second similarity. The prediction block for the current frame may be determined using the FMV.

The foregoing and/or other aspects are achieved by providing a method of performing prediction for multiview video processing, the method including obtaining at least one motion vector from a synthesized reference frame corresponding to a reference frame and a synthesized current block corresponding to a current block within a current frame, obtaining an RMV by refining the at least one motion vector through TM, and determining a ZMV between the current block and the reference frame. The method may further include determining an FMV between the RMV and the ZMV, by comparing the RMV and the ZMV.

The foregoing and/or other aspects are achieved by providing a method of performing prediction for multiview video processing, the method including determining a plurality of synthesized current frames corresponding to a current frame, determining a synthesized current block within each of the plurality of synthesized current frames corresponding to a current block within the current frame, determining a plurality of synthesized reference frames corresponding to a plurality of reference frames of the current frame, obtaining a plurality of motion vectors corresponding to pairs of the synthesized current block and the plurality of synthesized reference frames, and determining a single motion vector among the plurality of motion vectors, and determining a prediction block for the current frame using the determined motion vector.

The obtaining may include setting a restricted reference zone in each of the plurality of synthesized reference frames, determining at least one candidate block within the restricted reference zone, determining a synthesized reference block among the at least one candidate block, by comparing the synthesized current block and the at least one candidate block, with respect to each of the plurality of synthesized reference frames, and determining the plurality of motion vectors corresponding to the pairs of the synthesized current block and the plurality of synthesized reference frames, from the synthesized current block and the determined synthesized reference block. A size of the restricted reference zone may be greater than or equal to a size of the synthesized current block.

The method of may further include obtaining a plurality of RMVs, by refining motion vectors corresponding to pairs of the synthesized current block and the plurality of synthesized reference frames through TM. In this instance, the determining of the single motion vector and determining of the prediction block may include determining a single RMV among the plurality of RMVs, and determining the prediction block for the current frame using the determined RMV.

The method may further include determining a plurality of ZMVs between the current block and the plurality of reference frames, and determining an FMV among the plurality of RMVs and the plurality of ZMVs, by comparing the plurality of RMVs to the plurality of ZMVs. In this instance, the prediction block for the current frame may be determined using the determined FMV.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a structure of encoding multiview video data according to example embodiments;

FIG. 2 illustrates a hybrid multiview video encoder according to example embodiments;

FIG. 3 illustrates a search for a virtual motion vector (VMV) according to example embodiments;

FIG. 4 illustrates template matching (TM) according to example embodiments;

FIG. 5 illustrates a method of refining a VMV through TM according to example embodiments;

FIG. 6 illustrates a method of selecting between a refined motion vector (RMV) and a zero motion vector (ZMV) according to example embodiments;

FIG. 7 illustrates a weighting coefficient for calculating WSAD according to example embodiments;

FIG. 8 illustrates a bi-directional motion estimation according to example embodiments; and

FIG. 9 illustrates a method of searching for a displacement in a synthesized current frame according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

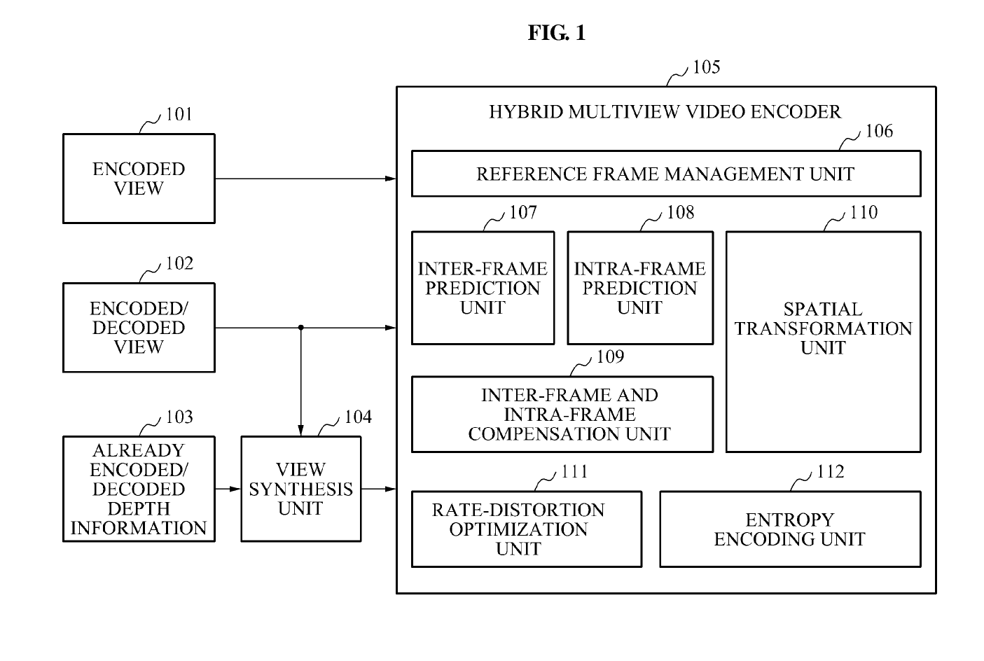

FIG. 1 illustrates a structure of encoding multiview video data according to example embodiments.

An encoded view 101 and an already encoded and decoded view 102 may be input into a hybrid multiview video encoder 105. A view synthesis unit 104 may receive the already encoded and decoded view 102 and already encoded and decoded depth information 103, and generate a synthesized view. The synthesized view may also constitute input data for the hybrid multiview video encoder 105.

The hybrid multiview video encoder 105 may encode the encoded view 101. As shown in FIG. 1, the hybrid multiview video encoder 105 may include a reference frame management unit 106, an inter-frame prediction unit 107, an intra-frame prediction unit 108, an inter-frame and intra-frame compensation unit 109, a spatial transformation unit 110, a rate-distortion optimization unit 111, and an entropy encoding unit 112. For details about the foregoing units, reference may be made to [Richardson I.E., “The H.264 Advanced Video Compression Standard”, Second Edition, 2010]. Example embodiments may be implemented by the inter-frame prediction unit 107.

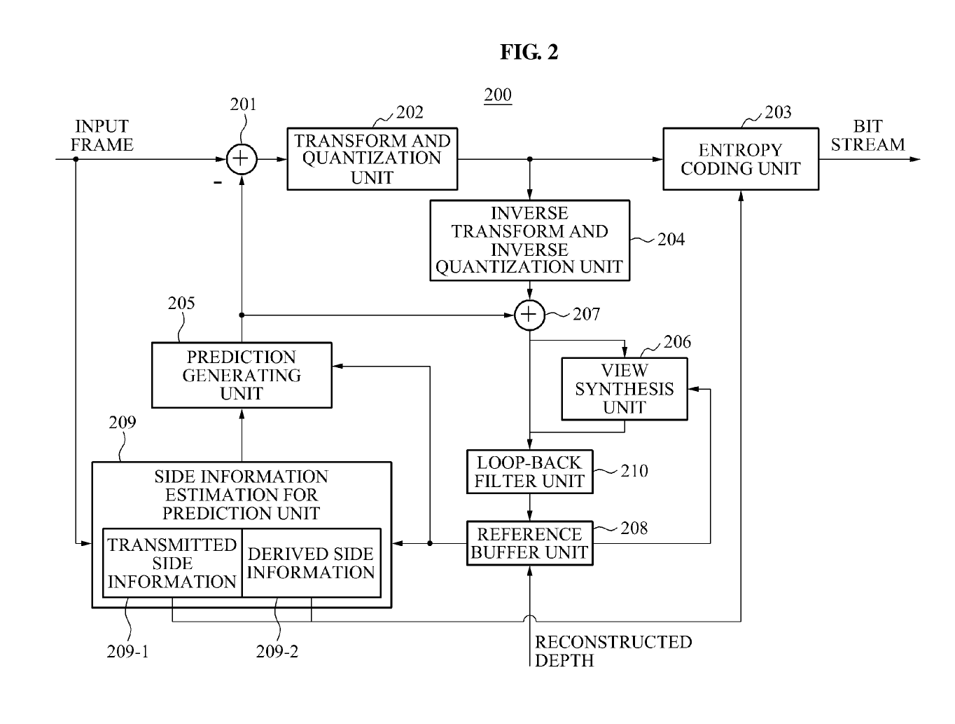

FIG. 2 illustrates a hybrid multiview video encoder 200 according to example embodiments.

Referring to FIG. 2, the hybrid multiview video encoder 200 may include a subtraction unit 201, a transform and quantization unit 202, an entropy encoding unit 203, an inverse transform and inverse quantization unit 204, a prediction generating unit 205, a view synthesis unit 206, an addition unit (compensation unit) 207, a reference buffer unit 208, a side information estimation for prediction unit 209, and a loop-back filter unit 210. For units 201 through 204, 207, and 210, units described in [Richardson I.E., “The H.264 Advanced Video Compression Standard”, Second Edition, 2010] may be used.

The view synthesis unit 206 may be a unit configured to encode MVD data. For example, the view synthesis unit 206 may synthesis a synthesized reference frame from an already encoded and decoded frame of already encoded views and depths.

The reference buffer unit 208 may store reconstructed depth information and the synthesized reference frame.

A motion estimation unit and a motion compensation unit which are described in [Richardson I.E., “The H.264 Advanced Video Compression Standard”, Second Edition, 2010] may be used for the prediction generating unit 205 and the side information estimation for prediction unit 209. The side information estimation for prediction unit 209 may include two subunits 209.1 and 209.2. The subunit 209.1 may generate side information to be explicitly transmitted to a decoder. The subunit 209.2 may generate side information that may be generated by the decoder without being transmitted.

A motion vector and an identifier of a reference frame indicated by the motion vector may constitute a main portion of side information of a current block. The motion vector may be estimated using a pixel of the current block and a pixel of a reference area. The estimated motion vector may be represented as a sum of a motion vector predictor component and a motion vector difference. The motion vector predictor component may be derived by the decoder, rather than being transmitted from an encoder to the decoder via a stream. The motion vector difference may be transmitted to the decoder via the stream, and used as side information. This representation may be used for efficient motion vector coding. A motion vector predictor may be calculated based on the motion vector derived from already encoded blocks.

Motion vector prediction and reference frame prediction may be performed using a synthesized reference frame, a reference frame from a video sequence of a currently encoded view, and a reconstructed (already encoded and decoded) pixel in the vicinity of a current block. A motion vector and a reference frame index for the current block may be derived based on reconstructed information. The reconstructed information may be identical to information on the encoder and decoder ends, which means that transmission of additional side information regarding a motion may be not required. Here, the additional side information may include, for example, information regarding a difference with respect to the motion vector prediction or a reference frame index.

A search for a motion vector and a reference frame index for a current block may be performed. As a result of the search, a reference frame or a reference frame index may be selected. The motion vector may indicate a block, and the block may correspond to a prediction block for the current block.

A current frame refers to a frame to be encoded and/or decoded by the encoder and/or the decoder. A current block refers to a block included in the current frame, and to be encoded and/or decoded by the encoder and/or the decoder.

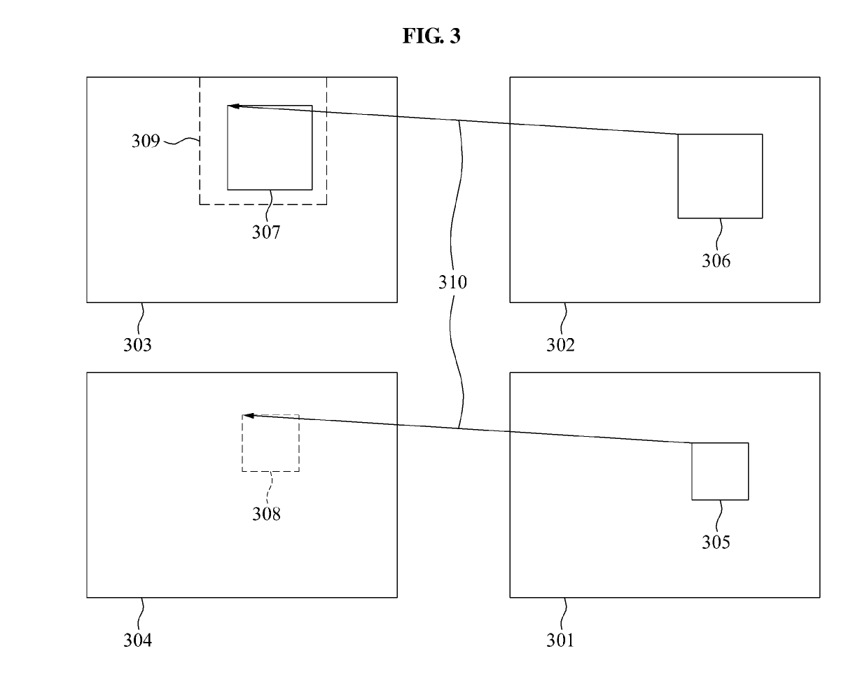

FIG. 3 illustrates a search for a virtual motion vector (VMV) according to example embodiments.

A VMV 310 for a synthesized current block 306 may be determined, and applied to a current block 305. It is important to search for a motion vector applicable to the current block 305. A generated prediction block may result in low residual.

A synthesized current frame 302 corresponding to a current frame 301 may be determined. The synthesized current block 306 within the synthesized current frame 302 corresponding to the current block 305 within the current frame 301 may be determined. A size of the synthesized current block 306 may be determined to be greater than or equal to a size of the current block 305.

A synthesized reference frame 303 corresponding to a reference frame 304 of the current frame 302 may be determined.

The current block 305 within the current frame 301 is shown in FIG. 3. In FIG. 3, the size of the current block 305 may be M×N, for example, 4×4. Here, M, and N denote integers greater than or equal to “1”. Coordinates of the current block 305 within the current frame 301 may be determined to be a left top corner, and may be assumed as (i, j).

The synthesized current block 306 may be selected from the synthesized current frame 302. A size of the synthesized current block 306 may be (M+2×OSx)×(N+2×OSy), for example, 8×8. 2×OSx, and 2×OSy denote integers greater than or equal to “1”. For more reliable estimation of a motion, the size of the current block 305 may differ from the size of the synthesized current block 306. Use of a current block 306 smaller than the current block 305 may result in an incorrect motion estimation. Accordingly, the size of the synthesized current block 306 may be greater than or equal to the current block 305. For example, when the synthesized current block 306 is selected, the synthesized current block 306 having a size greater than or equal to the size of the current block 305 may be selected.

According to an embodiment, coordinates of a center of the current block 305 may coincide with coordinates of a center of the synthesized current block 306.

According to another embodiment, coordinates of the synthesized current block 306 may be determined by a motion vector transmitted to a decoder through communication.

According to still another embodiment, coordinates of the synthesized current block 306 may be determined by a motion vector obtained through template matching. Here, the motion vector may not be transmitted to the decoder.

The coordinates of the synthesized current block 306 within the synthesized current frame 302 may be determined to be a left top corner, and may be defined as (i−OSx, j−OSy).

A search for the VMV 310 may be performed using the synthesized current block 306 and the synthesized reference frame 303. For example, with respect to the synthesized current block 306, a search for the VMV 310 may be performed in the synthesized reference frame 303. The synthesized reference frame 303 may correspond to the reference frame 304 of an encoded view. For example, the synthesized current frame 302 may be generated from the current frame 301 by a synthesis logic, and the synthesized reference frame 303 may be generated from the reference frame 304 by the synthesis logic.

The synthesis logic may use known synthesis methods. For example, a synthesized video sequence may be generated using depth information of a single view and a video sequence of a neighboring view. For example, a view synthesis method described in [S. Shimizu and H. Kimata Improved view synthesis prediction using decoder-side motion derivation for multiview video coding. Proc. IEEE 3DTV Conference, Tampere, Finland, June 2010] may be used. In this example, a synthesized frame with respect to a current frame and a reference frame may be generated using already encoded and reconstructed adjacent view and depth information.

The search for the VMV 310 may be performed by an exhaustive search within a restricted reference zone 309. The restricted reference zone 309 may be set to a zone having a size greater than or equal to the size of the synthesized current block 306, within the synthesized reference frame 303. According to another embodiment, the entirety of the synthesized reference frame 303 may be set to be the restricted reference zone 309. At least one candidate block may be determined within the restricted reference zone 309. A synthesized reference block 307 may be determined among the at least one candidate block, by comparing the at least one candidate block to the synthesized current block 306. The VMV 310 may be determined from the synthesized current block 306 and the determined synthesized reference block 307.

An integer-pixel search may be performed, and a quarter-pixel search may be performed around a best integer-pixel position.

The search may be performed through block comparison. The synthesized current block 306 may be compared to each block in the restricted reference zone 309 of the synthesized reference frame 303. For efficient comparison, a minimization factor coefficient may be preset. The minimization factor coefficient may be represented by a norm or a block similarity function. The minimization factor coefficient may be calculated with respect to pairs of the synthesized current block 306 and the at least one candidate block selected in the restricted reference zone 309. A candidate block having a minimum value of the minimization factor coefficient may be selected as a best block, and the best candidate block may be selected as the synthesized reference block 307.

When the synthesized reference block 307 is determined, the VMV 310 may be determined using the determined synthesized reference block 307. A displacement of the synthesized reference block 307 with respect to a position of the synthesized current block 306 may represent the VMV 310.

A determined VMV may be used for generating a prediction block 308.

When a VMV is determined, the VMV may be refined through template matching (TM). Refinement of the VMV, identical to refinement on an encoder side, may be performed on a decoder side without reference to an initial pixel value in the current block 305.

Pixels belonging to a neighborhood of a current block, but excluded from the current block, may be referred to as template. Pixels belonging to the template may correspond to already encoded and/or decoded pixels.

Through the TM, a refined motion vector (RMV) may be determined in a neighborhood of coordinates indicated by a VMV, within a corresponding reference frame. Although the TM has a disadvantage of detection of inaccurate motion side information, a portion of such a disadvantage may be overcome, by using a VMV derived through a synthesized current block corresponding to a current block. The VMV may be refined using a set of reconstructed pixels located in the vicinity of the current block. The set of reconstructed pixels located in the vicinity of a block may be referred to as template.

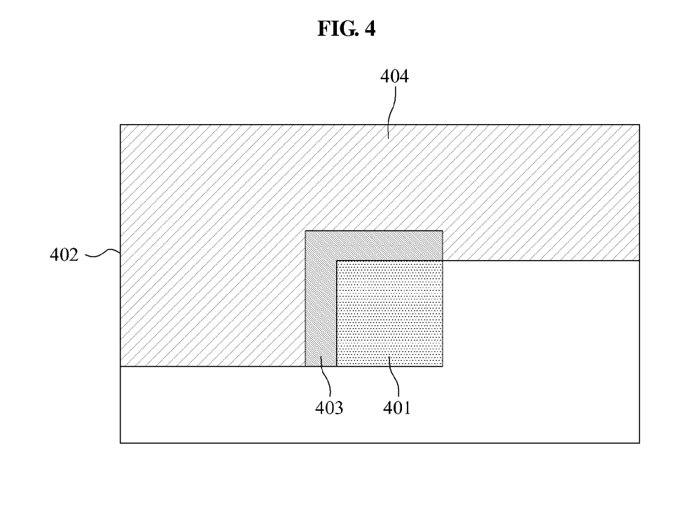

FIG. 4 illustrates TM according to example embodiments.

In order to derive motion information with respect to a current block 401 within a current frame 402 on both an encoder side and a decoder side, an inverse-L shaped template region 403 may be defined. The template region 403 may refer to a region expanded outwards from the current block 401, and have a width of a is pixel on a top side and a left side. Accordingly, a template may cover already reconstructed area 404 of the current frame 402.

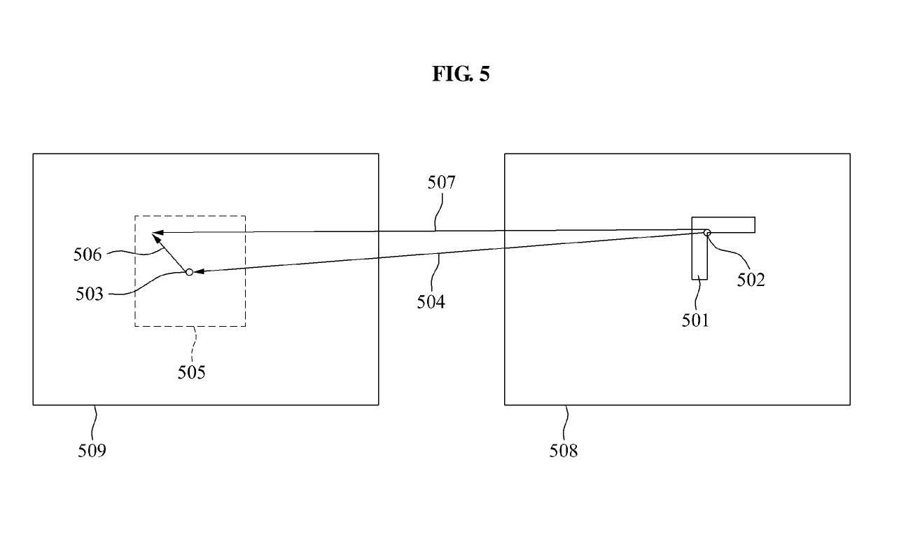

FIG. 5 illustrates a method of refining a VMV through TM according to example embodiments.

Referring to FIG. 5, a template 501 may be selected around a point 502 within a current frame 508. Coordinates of the point 502 may be assumed as (i, j), which may define a position of a current block within the current frame 805. A search in a reference frame 509 may be performed around a position 503 indicated by a VMV 504. A best displacement 506 may be determined by minimizing a norm between templates within the reference frame 509 and the current frame 508. A search for the best displacement 506 may be performed in a relatively small area 505.

The determined displacement 506 may be added to the VMV 504, and an RMV 507 may be determined RMV coordinates (i′, j′) of a prediction block for the current block may be determined. Here, (i′, j′)=(i, j)+VMV.

The determined RMV may be used for generating the prediction block.

In a number of actual videos, there may be a lot of stationary objects, for example, buildings, having zero motion vectors (ZMVs). In addition, when a VMV has a small random deviation as a result of a chaotic temporal shift distortion in a synthesized frame, a ZMV may be frequently a best choice. Accordingly, as an alternative prediction of a motion vector, the ZMV may be considered.

A first similarity between a template of the current block and a template indicated by the ZMV within the reference frame may be calculated. A second similarity between the template of the current block and a template indicated by the RMV within the reference frame may be calculated. By comparing the first similarity to the second similarity, a final motion vector (FMV) may be determined between the RMV and the ZMV.

A norm or a similarity function with respect to a template of the current block and a template set by the RMV may be calculated. A norm or a similarity function with respect to the template of the current block and a template set by the ZMV within the reference frame indicated by the RMV may be calculated. When the norm with respect to the ZMV is less than the norm with respect to RMV, a value of the RMV may be set to “0”. In this example, the ZMV may be selected as the FMV.

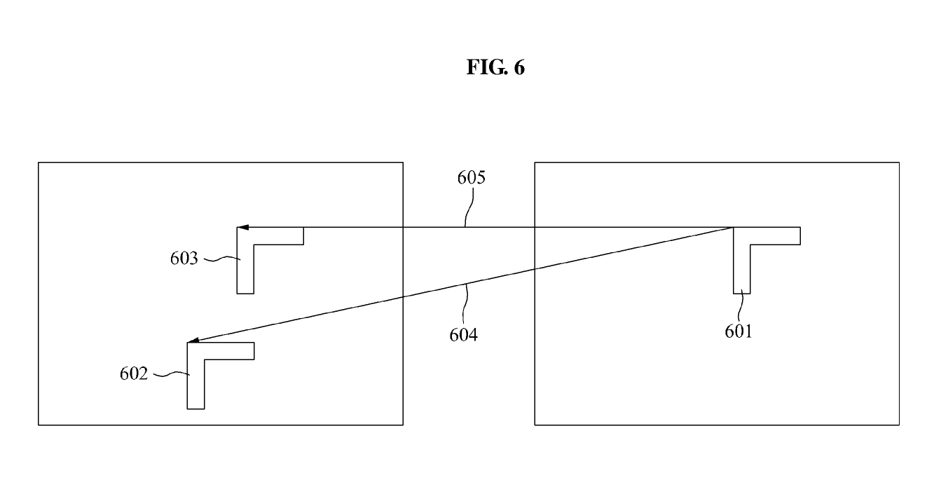

FIG. 6 illustrates a method of selecting between an RMV and a ZMV according to example embodiments.

A template-based technique may be used to select between the RMV and the ZMV.

Referring to FIG. 6, a first norm between a template 601 of a current block within a current frame and a template 602 indicated by an RMV 604 may be calculated. In addition, a second norm between the template 601 of the current block within the current frame and a template 603 having coordinates (i, j) within the reference frame may be calculated. It may correspond to applying a ZMV 605. The coordinates (i, j) indicate coordinates of the template 601 of the current block within the current frame. Coordinates of a template may be defined as coordinates of a top left pixel.

As a result of the computations, when the second norm is less than the first norm, the ZMV 605 may be determined to be an FMV. When the second norm is greater than or equal to the first norm, the RMV 604 may be determined to be the FMV.

The determined FMV may be used for generating a prediction block.

When a norm is used in the present embodiments, a minimization factor coefficient other than the norm, may be used. In addition, various norms may be used.

For example, when a search for a VMV is performed, norms used for a natural motion search and distortion images in [F. Tombari, L. Di Stefano, S. Mattoccia and A. Galanti. Performance evaluation of robust matching measures. In: Proc. 3rd International Conference on Computer Vision Theory and Applications (VISAPP 2008), pp. 473-478, 2008] may be used.

For example, a SAD norm (a sum of difference moduluses) may be used.

$$S A D = {\sum }_{m = i - OSx}^{i + M + 2 \cdot OSx} {\sum }_{n = j - OSy}^{j + N + 2 \cdot OSy} \vert Es [ m , n ] - Rs [ m + vmvx , n + vmvy ] \vert \qquad [ Equation 1 ]$$

In Equation 1, Es[m, n] denotes a value of a pixel of a synthesized current block within a synthesized current frame Es. Rs[m+vmvx, n+vmvy] denotes a value of a pixel of a synthesized reference block within a synthesized reference frame Rs. The synthesized reference block may be indicated by a candidate virtual motion vector [vmvx, vmvy]. [m, n] denotes coordinates of a pixel within a frame.

When an RMV is determined and/or when an FMV is determined between an RMV and a ZMV, a TM technique may be used. In this instance, the following two norms may be used.

A first norm may be a weighted SAD norm, referred as WSAD.

$$W S A D = {\sum }_{for all ( m , n ) pixel ∈ template} [ w ( m , n ) \cdot \vert Et [ m , n ] - Rt [ m + rmvx , n + rmvy ] \vert ] \qquad [ Equation 2 ]$$

In Equation 2, Et[m, n] denotes a value of a reconstructed pixel of a template within a current frame Et. Rt[m+rmvx, n+rmvy] denotes a value of a pixel of a template within a reference frame Rt. [rmvx, rmvy] denotes coordinates of a ZMV or a candidate RMV. A weighting coefficient w(m, n) may be determined with respect to each pixel of coordinates [m, n] within a template.

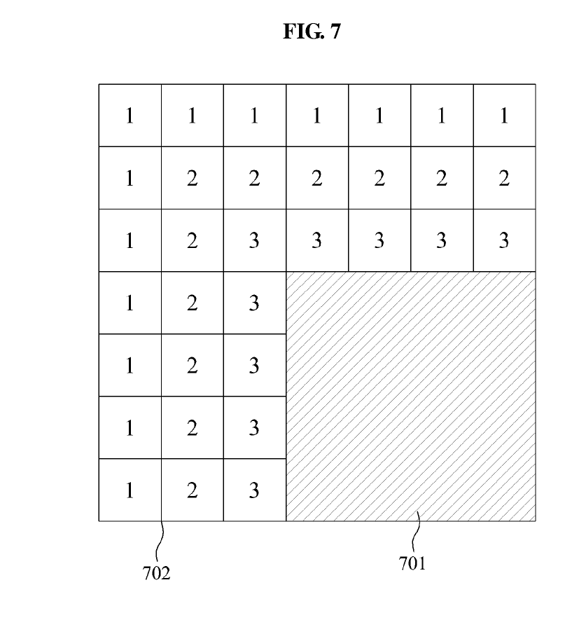

FIG. 7 illustrates a weighting coefficient for calculating WSAD according to example embodiments. A weighting coefficient w(m, n) may be equal to a difference between a size ts of a template and a shortest distance from a current pixel with coordinates [m, n] of a template 702 to a current block 701. In FIG. 7, ts=3.

A second norm GradNorm may be based on local gradients.

$$GradNorm = {\sum }_{for all ( m , n ) pixels ∈ template} [ {( ghE ( m , n ) - ghR ( m , n ) )}^{2} + {( gvE ( m , n ) - gvR ( m , n ) )}^{2} ] , \\ where \\ ghE ( m , n ) = \frac{\begin{matrix}Et ( m , n + 1 ) - Et ( m , n ) + \\ Et ( m + 1 , n + 1 ) - Et ( m + 1 , n )\end{matrix}}{2} , \\ ghR ( m , n ) = \frac{\begin{matrix}Rt ( {m}^{′} , {n}^{′} + 1 ) - Rt ( {m}^{′} , {n}^{′} ) + \\ Rt ( {m}^{′} + 1 , {n}^{′} + 1 ) - Rt ( {m}^{′} + 1 , {n}^{′} )\end{matrix}}{2} , \\ gvE ( m , n ) = \frac{\begin{matrix}Et ( m + 1 , n ) - Et ( m , n ) + \\ Et ( m + 1 , n + 1 ) - Et ( m , n + 1 )\end{matrix}}{2} , \\ gvR ( m , n ) = \frac{\begin{matrix}Rt ( {m}^{′} + 1 , {n}^{′} ) - Rt ( {m}^{′} , {n}^{′} ) + \\ Rt ( {m}^{′} + 1 , {n}^{′} + 1 ) - Rt ( {m}^{′} , {n}^{′} + 1 )\end{matrix}}{2} , \\ {m}^{′} = m + rmvx , {n}^{′} = n + rmvy . \qquad [ Equation 3 ]$$

In Equation 3, Et(m, n) denotes a value of a reconstructed pixel of a template of a current block. Rt(m+rmvx, n+rmvy) denotes a value of a pixel of a template indicated by a candidate RMV (rmvx, rmvy). When coordinates (m+1, n), (m, n+1), or (m+1, n+1) are out of the template, pixels of a reference frame Rt may be used instead of corresponding pixels Et.

In addition, according to example embodiments, a plurality to reference frames may be used. A search for a motion vector with respect to each of the plurality of reference frames may be performed, a reference frame having a best motion vector, for example, a motion vector having a minimum norm, may be selected as a final reference frame.

When a plurality of reference frames are available, in the example embodiments described above, operations related to a reference frame may be performed with respect to each of the plurality of reference frames. A reference frame indicated as having a smallest norm may be selected, based on a VMV, an RMV, or an FMV. The selected reference frame may be used as a reference frame in other operations.

There is provided a method of deriving a plurality of motion vectors with respect to a current block. Through the method, multi-hypotheses prediction, for example, bi-directional prediction, may be performed. In this instance, motion vectors may be referred to as hypotheses. The multiple hypotheses may be used for generating an integrated prediction block. For example, by averaging blocks indicated by each hypothesis, the integrated prediction block may be generated. Such hypotheses used for generating the integrated prediction block may be referred to as a set of hypotheses. A method of deriving a set of hypotheses may include an operation of searching for at least two RMVs constituting the set. The search may be performed around centers indicated by previously refined motion vectors or VMVs within corresponding reference frames, through the TM scheme.

There is also provided a method of determining a best set of hypotheses among possible candidate sets. A reference template may be generated by calculating the reference template based on a plurality of templates indicated by the candidate sets. Calculation of each pixel value of the reference template may include a process or averaging all pixel values of corresponding pixel locations. A minimization criterion or a norm between the reference template and a template of a current block may be calculated. Here, the norm may be used for determining the best set of hypotheses among all candidate sets.

A weighting coefficient may be calculated with respect to each prediction block indicated by a corresponding hypothesis from a set of hypotheses, as a function of a norm. The norm may be calculated between a template indicated by a hypothesis and a template of a current block. For example, the weighting coefficient W=exp(−C*Norm) may be used. Here, C denotes a predetermined constant greater than “0”. The multi-hypothesis prediction may be performed using the calculated weighting coefficient and a prediction block indicated by a corresponding hypothesis.

There is also provided multi-hypothesis prediction. Here, one of hypotheses may indicate a synthesized current frame, and calculation of a weighting coefficient with respect to each prediction block may be performed the following operations. A weighting coefficient with respect to a prediction block indicated by a hypothesis pointing out a synthesized current frame may be calculated, as a function of a norm. The norm may be calculated between a template of a current block and a template indicated by a hypothesis. The norm may exclude a difference between an average of reconstructed pixel values of the template of the current block and an average level of pixel values of the template indicated by the hypothesis. In the calculation, mean-removed pixel values may be used. For example, when the norm constitutes a sum of difference moduluses, a process of calculating mean-removed SAD (MRSAD) may include a process of Equation 4. Here, the calculated MRSAD may be used as a norm, depending on an example embodiment.

$$M R S A D = {\sum }_{for all ( m , n ) pixels ∈ template} [ \vert ( Et [ m , n ] - Rt [ m , n ] ) - ( MeanEt - MeanRt ) \vert ] \\ MeanEt = \frac{{\sum }_{all ( m , n ) ∈ template} [ Et ( m , n ) ]}{\vert Template \vert} \\ MeanRt = \frac{{\sum }_{all ( m , n ) ∈ template} [ Rt ( m , n ) ]}{\vert Template \vert} \qquad [ Equation 4 ]$$

In Equation 4, Et(m, n) denotes a value of a reconstructed pixel of the template of the current block. Rt(m, n) denotes a value of a reconstructed pixel of the template indicated by the hypothesis. |Template| denotes a number of pixels within a template.

The multi-hypothesis prediction may be performed using the prediction block indicated by the hypothesis pointing out the synthesized current frame. An illumination and contrast correction of the prediction block indicated by the hypothesis pointing out the synthesized current frame may be performed. The multi-hypothesis prediction may be performed using the corrected prediction block and a weighting coefficient with respect to the corrected prediction block.

The prediction block may be generated using a plurality of reference frames. In particular, a plurality of synthesis current frames corresponding to the current frame may be determined A synthesized current block within each of the plurality of synthesized current frames corresponding to a current block within the current frame may be determined A plurality of synthesized reference frames corresponding to a plurality of reference frames of the current frame may be determined A plurality of motion vectors corresponding to pairs of the synthesized current block and the plurality of synthesized reference frames may be obtained. A single motion vector may be determined among the plurality of motion vectors, and a prediction block for the current frame may be determined using the determined motion vector.

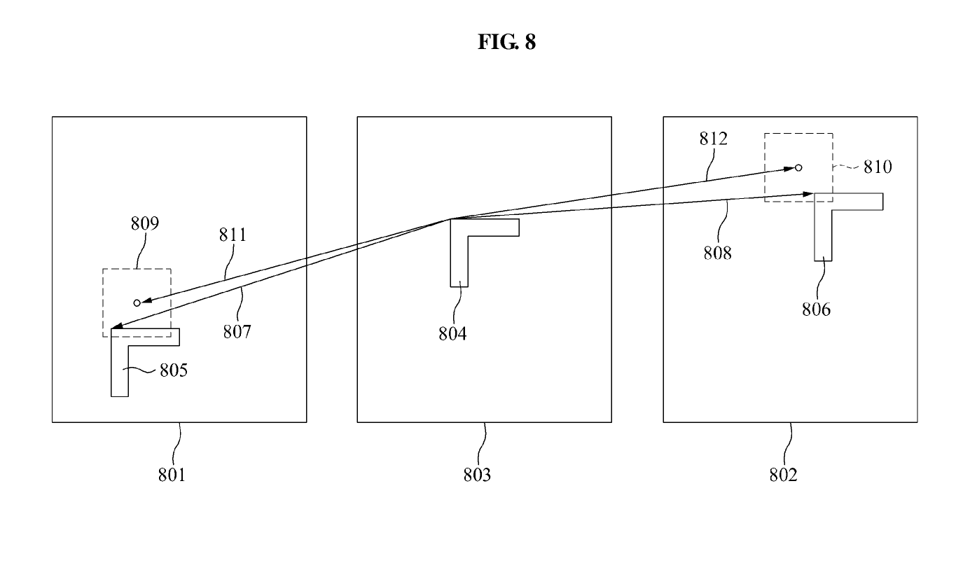

FIG. 8 illustrates a bi-directional motion estimation according to example embodiments.

According to example embodiments, a bi-directional motion estimation may be used. In the present embodiments, two predictors may be summated, and a result of the summation or a weighted sum may be used as a final predictor. Such motion vectors may indicate different reference frames.

With respect to each synthesized reference frame, as many VMVs as a number of the synthesized reference frames may be obtained using the method described above. With respect to each reference frame, an RMV and a ZMV may be obtained using the method described above. With respect to each reference frame, an FMV may be obtained using the method described above. The obtained FMV may be stored with respect to each reference frame.

In addition, an RMV, a ZMV, or a VMV obtained with respect to each reference frame may be selected as an FMV, and stored with respect to each reference frame.

Referring to FIG. 8, an adjustment of each pair FMVᵣ₁, FMVᵣ₂ from reference frames r1 and r2 may be performed.

$$( {biFMV}_{r 1} , {biFMV}_{r 2} ) = {argmin}_{{mv}_{r 1} ∈ {SA}_{s 1} , {mv}_{r 2} ∈ {SA}_{r 2}} [ Norm ( Et , biRt ( {mv}_{r 1} , {mv}_{r 2} ) ) ] , \\ biRt ( {mv}_{r 1} , {mv}_{r 2} ) = \frac{{Rt}_{r 1} ( {mv}_{r 1} ) + {Rt}_{r 2} ( {mv}_{r 2} )}{2} \qquad [ Equation 5 ]$$

In Equation 5, Norm denotes GradNorm or WSAD. biFMVᵣ₁,biFMVᵣ₂ denotes an adjusted bi-directional motion vector. biRt(mvᵣ₁,mvᵣ₂) denotes a half-sum of templates from a reference frame r1 801 and a reference frame r2 802. Et denotes a template 804 of a current block within a current frame 803. Rtᵣ₁(mvᵣ₁) and Rtᵣ₂(mvᵣ₂) denote templates 805 and 806 from the reference frame r1 801 and the reference frame r2 802 indicated by candidate vectors mvᵣ₁ 807 and mvᵣ₂ 808. SAᵣ₁ and SAᵣ₂ denote small areas 809 and 810 within the reference frame r1 801 and the reference frame r2 802 around FMVᵣ₁ 811 and FMVᵣ₂ 812.

A pair (biFMVᵣ₁,biFMVᵣ₂) having a best norm from all possible pairs (r1,r2) may be selected as a final bi-directional motion vector biFMV.

Since a norm with respect to the final bi-directional motion vector biFMV and a norm with respect to a final one-directional motion vector FMV have similar dimensions, the norm with respect to the final bi-directional motion vector biFMV may be compared directly to the norm with respect to the final one-directional motion vector FMV. Accordingly, it is possible to select a best motion vector from the final bi-directional motion vector biFMV and the final one-directional motion vector FMV. The final bi-directional motion vector biFMV may be used for motion compensation for obtaining a prediction block from the reference frames.

Motion vectors may not be transmitted to a decoder and thus, a communication load may not increase. Accordingly, motion vectors with respect to each reference frame may be obtained.

In addition, weighted predictors may be used in lieu of averaging suggested in [S. Kamp, J. Ball'e, and M. Wien. Multihypothesis Prediction using Decoder Side Motion Vector Derivation in Inter Frame Video Coding. In Proc. of SPIE Visual Communications and Image Processing VCIP '09, (San Jose, Calif., USA), SPIE, Bellingham, January 2009]. For example, weighting coefficients W=exp(−C*Norm) may be used. Here, C denotes a predetermined constant greater than “0”, and Norm denotes a minimization factor coefficient, for example, a similarity function, with respect to a vector indicating a prediction block derived from a TM procedure.

Mixing of a prediction from temporal reference frames and a prediction from a synthesized current frame may represent a special interest. Such an approach may include generation of the prediction block from the synthesized current frame. Due to distortions within the synthesized current frame, a local displacement vector Disp may exist between a current block and a corresponding block within the synthesized current frame. In order to avoid an increase in a bit rate of a compressed stream, it may be worth deriving the displacement at both the encoder side and the decoder side simultaneously.

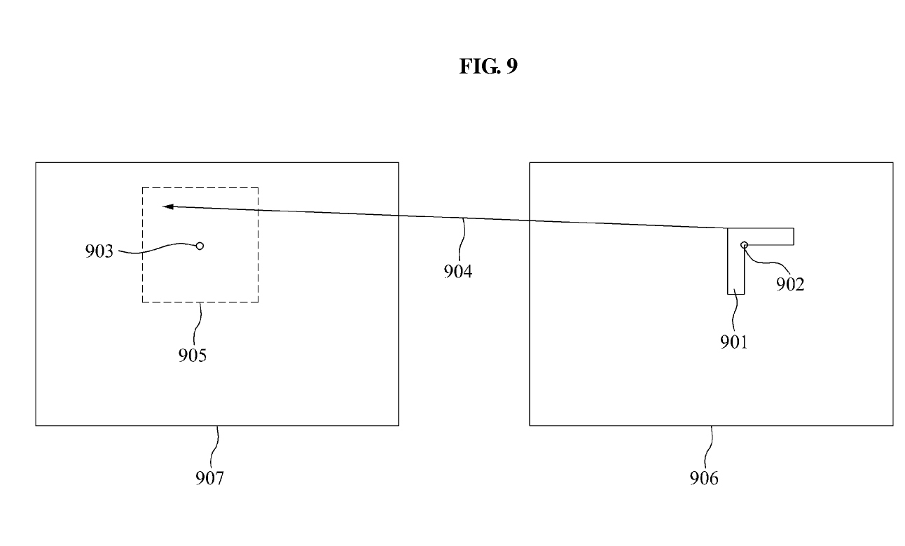

FIG. 9 illustrates a method of searching for a displacement in a synthesized current frame according to example embodiments.

Referring to FIG. 9, a template 901 may be selected around a point [i, j] 902. The point [i, j] 902 may define a position of a current block within a current frame 906. A template search may be performed around a point [i, j] 903 within a synthesized current frame 907. By minimizing a norm between templates within the synthesized current frame 907 and the current frame 906, a best displacement Disp 904 may be determined. The determination of the best displacement Disp 904 may be performed in a small area 905. A size of the area 905 may correspond to a few quarterOpixel samples with respect to each axis.

A synthesized prediction block sPb may be determined using the best displacement Disp 904. Due to a difference between views, for example, various brightnesses and contrasts, a linear model may be used for calculation of a corrected synthesized prediction block sPb^{corr}.

sPb^{corr}=α·(sPb−MeanEs)+MeanEt [Equation 6]

In order to obtain parameters α,MeanEt,MeanEs, Et[m, n] and Es[m+rmvx, n+rmvy] may be used. Et[m, n] denotes a value of a pixel of a template of the current block within the current frame. Es[m+rmvx, n+rmvy] denotes a value of a pixel of a template of the synthesized prediction block within the synthesized current frame.

$$α = \frac{{\sum }_{all ( m , n ) ∈ template} [ \begin{matrix}( Et ( m , n ) - MeanEt ) \cdot \\ ( Es ( m , n ) - MeanEs )\end{matrix} ]}{{\sum }_{all ( m , n ) ∈ template} [ {( Es ( m , n ) - MeanEs )}^{2} ]} \\ MeanEt = \frac{{\sum }_{all ( m , n ) ∈ template} [ Et ( m , n ) ]}{\vert Template \vert} \\ MeanEs = \frac{{\sum }_{all ( m , n ) ∈ template} [ Es ( m , n ) ]}{\vert Template \vert} \qquad [ Equation 7 ]$$

In Equation 7, |Template| denotes a number of pixels within a template.

A simple additive model may be useful when α=1.

Various norms may be used. For example, a weighted mean removed SAD (WMRSAD) may be used as a norm. WMRSAD may be expressed by Equation 8.

$$W M R S A D = {\sum }_{for all ( m , n ) pixels ∈ template} [ w ( m , n ) \cdot \vert ( Et [ m , n ] - Es [ m + rmvx , n + rmvy ] ) - ( MeanEt - MeanEs ) \vert ] \qquad [ Equation 8 ]$$

A weighting coefficient w(m, n) may be calculated in a manner similar to that described in the definition of WSAD.

Equation 8 may result in the corrected synthesized prediction block sPb^{corr} derived from the synthesized current frame. In addition, a prediction block tPb may be obtained from the reference frames by the identical procedure. In order to obtain a final prediction block fPb, weighted summation of predictors sPb^{corr} and tPb may be performed.

$$fPb = \frac{wt \cdot tPb + ws \cdot {sPb}^{corr}}{wt + ws} \qquad [ Equation 9 ]$$

Weighting coefficients wt and ws denote norms calculated using templates indicated by derived motion vectors. The weighting coefficients wt and ws may be used for forming sPb^{corr} and tPb, respectively. wt may be defined by a derived motion vector related to sPb^{corr}, and ws may be defined by a derived motion vector related to tPb.

The example embodiments may provide a method of reducing side information within a framework of multi-view video with depth information (MVD) video compression. The example embodiments may be easily integrated into current and future compression systems, for example, Multiview Video Coding (MVC) and High Efficiency Video Coding (HEVC) three-dimensional (3D) codecs. The example embodiments may support an MVC-compatibility mode for different prediction structures. An additional computation payload of a decoder may be compensated by quick motion vector estimation technologies. In addition, the example embodiments may be combined with other techniques that may increase a compression efficiency of MVD streams.

In addition, the example embodiments may be implemented by an encoder and/or a decoder. When the example embodiments are implemented at the encoder side, a current frame and a current block may refer to a frame and a block to be encoded. When the example embodiments are implemented at the decoder side, a current frame and a current block may refer to a frame and a block to be decoded.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, to other implementations are within the scope of the following claims.

What is claimed is:

1. A method of performing prediction for multiview video processing, the method comprising:
determining a synthesized current frame corresponding to a current frame;
determining a synthesized current block in the synthesized current frame corresponding to a current block in the current frame;
determining a synthesized reference frame corresponding to a reference frame of the current frame;
obtaining at least one motion vector from the synthesized current block and the synthesized reference frame; and
determining a prediction block for the current frame using the at least one motion vector.

2. The method of claim 1, wherein the obtaining comprises:
setting a restricted reference zone within the synthesized reference frame;
determining at least one candidate block within the restricted reference zone;
determining a synthesized reference block among the at least one candidate block, by comparing the at least one candidate block to the synthesized current block; and
determining the at least one motion vector from the synthesized current block and the determined synthesized reference block.

3. The method of claim 2, wherein a size of the restricted reference zone is greater than or equal to a size of the synthesized current block.

4. The method of claim 1, wherein a size of the synthesized current block is greater than or equal to a size of the current block.

5. The method of claim 1, wherein coordinates of a center of the synthesized current block within the synthesized current frame coincide with coordinates of a center of the current block within the current frame.

6. The method of claim 1, further comprising obtaining a refined motion vector (RMV) by refining the at least one motion vector through template matching (TM),
wherein the determining of the prediction block comprises determining the prediction block for the current frame using the RMV.

7. The method of claim 6, wherein the obtaining of the RMV comprises:
determining a first template related to the current block;
determining a best displacement related to the reference frame and the first template through the TM; and
obtaining the RMV by adding the determined best displacement to the at least one motion vector.

8. The method of claim 6, further comprising:
determining a zero motion vector (ZMV) between the current block and the reference frame; and
determining a final motion vector (FMV) between the RMV and the ZMV, by comparing the RMV to the ZMV,
wherein the determining of the prediction block comprises determining the prediction block for the current frame using the FMV.

9. The method of claim 8, wherein the determining of the FMV comprises:
calculating a first similarity between a template of the current block and a template indicated by the ZMV within the reference frame;
calculating a second similarity between the template of the current block and a template indicated by the RMV within the reference frame; and
determining the FMV between the RMV and the ZMV, by comparing the first similarity to the second similarity.

10. A method of performing prediction for multiview video processing, the method comprising:
obtaining at least one motion vector from a synthesized reference frame corresponding to a reference frame and a synthesized current block corresponding to a current block within a current frame;
obtaining a refined motion vector (RMV) by refining the at least one motion vector through template matching (TM); and
determining a prediction block for the current frame using the RMV.

11. The method of claim 10, further comprising:
determining a zero motion vector (ZMV) between the current block and the reference frame; and
determining a final motion vector (FMV) between the RMV and the ZMV, by comparing the RMV to the ZMV,
wherein the determining of the prediction block comprises determining the prediction block for the current frame using the FMV.

12. The method of claim 10, wherein the obtaining of the at least one motion vector comprises:
setting a restricted reference zone within the synthesized reference frame;
determining at least one candidate block within the restricted reference zone;
determining a synthesized reference block among the at least one candidate block, by comparing the at least one candidate block to the synthesized current block; and
determining the at least one motion vector from the synthesized current block and the determined synthesized reference block.

13. A method of performing prediction for multiview video processing, the method comprising:
determining a plurality of synthesized current frames corresponding to a current frame;
determining a synthesized current block within each of the plurality of synthesized current frames corresponding to a current block within the current frame;
determining a plurality of synthesized reference frames corresponding to a plurality of reference frames of the current frame;
obtaining a plurality of motion vectors corresponding to pairs of the synthesized current block and the plurality of synthesized reference frames; and
determining a single motion vector among the plurality of motion vectors, and
determining a prediction block for the current frame using the determined motion vector.

14. The method of claim 13, wherein the obtaining comprises:
setting a restricted reference zone in each of the plurality of synthesized reference frames;
determining at least one candidate block within the restricted reference zone;
determining a synthesized reference block among the at least one candidate block, by comparing the synthesized current block and the at least one candidate block, with respect to each of the plurality of synthesized reference frames; and
determining the plurality of motion vectors corresponding to the pairs of the synthesized current block and the plurality of synthesized reference frames, from the synthesized current block and the determined synthesized reference block.

15. The method of claim 14, wherein a size of the restricted reference zone is greater than or equal to a size of the synthesized current block.

16. The method of claim 14, wherein a size of the synthesized current block is greater than or equal to a size of the current block.

17. The method of claim 14, further comprising:
obtaining a plurality of refined motion vectors (RMVs), by refining motion vectors corresponding to pairs of the synthesized current block and the plurality of synthesized reference frames through template matching (TM),
wherein the determining of the single motion vector and determining of the prediction block comprises determining a single RMV among the plurality of RMVs, and
determining the prediction block for the current frame using the determined RMV.

18. The method of claim 17, wherein the obtaining of the plurality of RMVs comprises:
determining a first template related to the current block;
determining a best displacement related to each of the plurality of reference frames and the first template through the TM, with respect to each of the plurality of reference frames; and
obtaining the plurality of RMVs corresponding to the pairs of the synthesized current block and the plurality of synthesized reference frames, by adding the determined best displacement to the plurality of motion vectors.

19. The method of claim 17, further comprising:
determining a plurality of zero motion vectors (ZMVs) between the current block and the plurality of reference frames; and
determining a final motion vector (FMV) among the plurality of RMVs and the plurality of ZMVs, by comparing the plurality of RMVs to the plurality of ZMVs,
wherein the determining of the prediction block comprises determining the prediction block for the current frame using the determined FMV.

20. A non-transitory computer-readable medium comprising a program for instructing a computer to perform the method of claim 1.
